(19) United States
(12) Patent Application Publication
(10) Pub. No.: US 2026/0363962 A1
(43) Pub. Date: Nov. 19, 2026

(54) Sleeve for Use by an Infant or Child for Holding a Fluid Container

(71) Applicant: Alex Avery Fields, Kerrville, TX (US)

(72) Inventor: Alex Avery Fields, Kerrville, TX (US)

(21) Appl. No.: 19/207,688

(22) Filed: May 14, 2025

(51) Int. Cl. A61J 9/06

(52) U.S. Cl. CPC A61J 9/0669; A61J 9/0623

(57) ABSTRACT

The present invention discloses a rectangular piece of flexible material that can form a sleeve with handles for use by an infant or child for holding a fluid container, such as a baby bottle, without the assistance of a caregiver and allows the baby to feed or drink by itself. When the piece of material forms a sleeve, a second sleeve fastening device overlaps with and fastens to a first sleeve fastening device to secure the sleeve in place around the fluid container. Ribbons extending from the top edge of the piece of material are folded over and fastened to the piece of material to form the handles. The baby's hands can then be positioned within the handle.

### CROSS-REFERENCES TO RELATED APPLICATIONS

Not applicable

### STATEMENT REGARDING FEDERALLY SPONSORED RESEARCH OR DEVELOPMENT

Not applicable.

### BACKGROUND OF THE INVENTION

### 1. Field of the Invention

The present invention is directed to a piece of flexible material with ribbons that can form a sleeve with handles that can be placed around a fluid container to help infants and children hold the fluid container and self-feed.

### 2. Background of Related Art

Most infants and toddlers have trouble gripping and holding feeding bottles which leads to infants and toddlers relying on assistance from caregivers during feeding time. The baby's need for assistance poses a problem for both the baby and the caregiver. Baby bottles have been created to help deal with this problem, but they have limitations and issues. For example, prop feeding devices involves propping a bottle against the device and allows hands-free feeding, however, these types of devices can lead to the baby choking. Another example are bottles with either built-in or removable handles. These types of bottles require the baby or toddler to grasp and hold onto the handle, which many younger babies are not capable of doing. Thus, there is a need for improvement of current technology.

The present invention improves these deficiencies by using a sleeve with a detachable handle that can be strapped around a baby's hands. The present invention helps babies hold onto their feeding container independently so they can safely feed themselves and also helps babies and toddlers develop a stronger grip and hand-eye coordination.

### SUMMARY OF THE INVENTION

The present invention discloses a rectangular piece of flexible material with ribbons that can form a sleeve with handles for use by an infant or child for holding a fluid container, such as a baby bottle. The piece of material comprises a first surface, a second surface, a first side end, a second side end, a top edge, a bottom edge, first and second ribbons, first and second elements of a sleeve fastening device, and first and second elements of first and second handle fastening devices. The piece of material is sized to fit around a fluid container when the piece of material forms a sleeve. The ribbons extend from the top edge of the piece of material and are made of flexible material.

The first sleeve fastening device is positioned on the first surface of the piece of material adjacent to the first side end. The second sleeve fastening device is positioned on the second surface of the piece of material adjacent to the second side end. When the piece of material forms the sleeve, the second sleeve fastening device overlaps with and fastens to the first sleeve fastening device to secure the sleeve in place around the fluid container.

Each first handle fastening device is positioned adjacent to the top end of the ribbon. Each of the second handle fastening devices are positioned on the first surface of the piece of material adjacent to the bottom edge. Each of the second handle fastening devices are positioned below one of the first handle fastening devices such that when each ribbon is folded over, the first handle fastening device of the ribbon can fasten to the second handle fastening device of the piece of material to form a handle with a space between the ribbon and the piece of material.

The piece of material forms a sleeve with handles that is positioned around the fluid container and allows a baby to hold onto the fluid container, such as a baby bottle, without the assistance of a caregiver and allows the baby to feed or drink by itself. The sleeve is formed by wrapping the piece of material around the fluid container and fastening the first sleeve fastening device to the second sleeve fastening device. To form the handles, each of the ribbons are folded over and the first handle fastening device is fastened to the corresponding second handle fastening device. The baby's hands can then be positioned within the space between the handle and the first surface of the piece of material.

### BRIEF SUMMARY OF THE DRAWINGS

The present invention, as well as further objects and features thereof, are more clearly and fully set forth in the following description of the preferred embodiment, which should be read with reference to the accompanying drawings, wherein:

FIG. 1 is a front view of the preferred embodiment of the flexible piece of material of the present invention.

FIG. 2 is a back view of the preferred embodiment of the flexible piece of material of the present invention.

FIG. 3 is a perspective view of the preferred embodiment of the sleeve with ribbons forming handles in accordance with the present invention.

FIG. 4 is a perspective view of the preferred embodiment of the sleeve positioned around a fluid container with a baby's hands positioned within the ribbons forming handles to demonstrate the intended use of the present invention.

### DETAILED DESCRIPTION

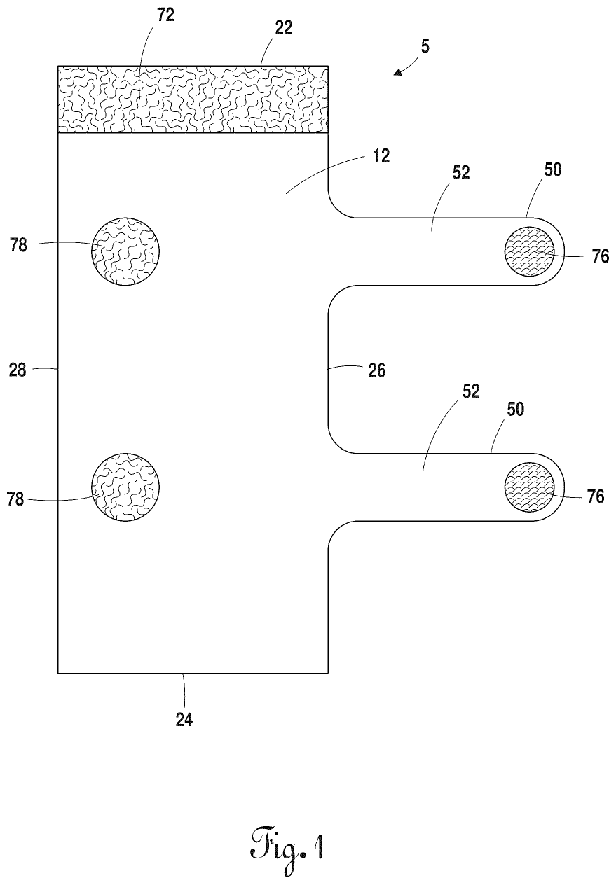

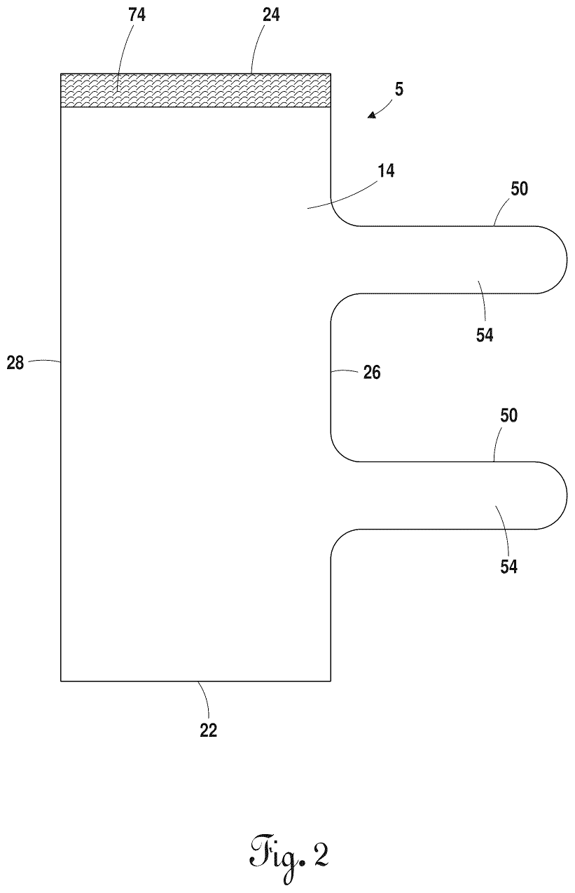

As shown in FIG. 1-4, the piece of material 5 comprises a first surface 12, a second surface 14, a first side end 22, a second side end 24, a top edge 26, a bottom edge 28, ribbons 50, a first sleeve fastening device 72, a second sleeve fastening device 74, first handle fastening devices 76, and second handle fastening devices 78.

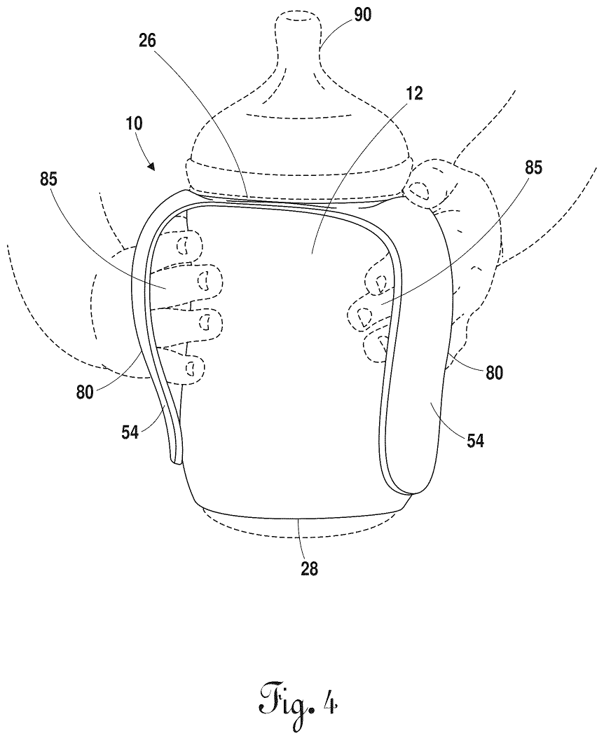

The piece of material 5 is generally rectangular in shape and is made of flexible material. In the preferred embodiment, the piece of material 5 is made of neoprene, but other materials are envisioned. The piece of material 5 is sized to fit around a fluid container 90, such as a baby bottle, when the piece of material 5 forms a sleeve 10 positioned around the fluid container 90, as shown in FIG. 4.

As show in FIG. 1-4, the first surface 12 of the piece of material 5 faces away from the fluid container 90 when the sleeve 10 is positioned around the fluid container 90. The second surface 14 of the piece of material 5 faces toward and in contact with the fluid container 90 when the sleeve 10 is positioned around the fluid container 90. In the preferred embodiment, the top edge 26 of the piece of material 5 is positioned adjacent to the opening end of the fluid container 90, and the bottom edge 28 of the piece of material 5 is positioned adjacent to the bottom end of the fluid container 90, when the sleeve 10 is positioned around the fluid container 90.

The ribbons 50 extend from the top edge 26 of the piece of material 5 and are made of flexible material. Each ribbon 50 comprises a first surface 52 and a second surface 54. The first surface 52 of each ribbon 50 is coplanar with the first surface 12 of the piece of material 5, and the second surface 54 of each ribbon 50 is coplanar with the second surface 54 of the piece of material 5. In the preferred, there are two ribbons 50 and each ribbon 50 is made from the same flexible material as the piece of material 5, but more or less ribbons 50 and other materials are envisioned.

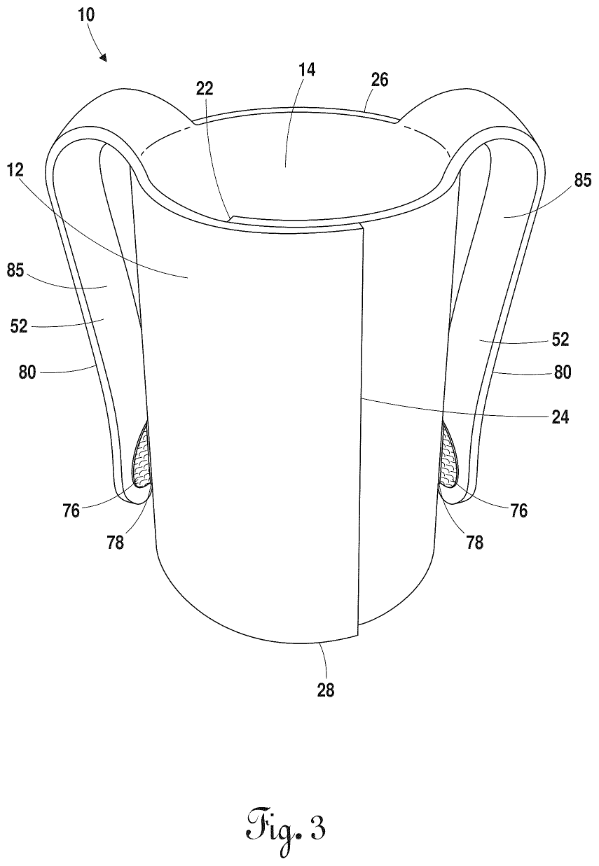

The first sleeve fastening device 72 is positioned on the first surface 12 of the piece of material 5 adjacent to the first side end 22 of the piece of material 5. The second sleeve fastening device 74 is positioned on the second surface 14 of the piece of material 5 adjacent to the second side end 24 of the piece of material 5. In the preferred embodiment, the first sleeve fastening device 72 and second sleeve fastening device 74 are hook and loop fasteners, but other embodiments, including but not limited to snaps, are envisioned. As shown in FIGS. 3 and 4, when the piece of material 5 forms the sleeve 10, the second sleeve fastening device 74 overlaps with and fastens to the first sleeve fastening device 72 to secure the sleeve 10 in place around the fluid container 90. In the preferred embodiment, the width of the sleeve fastening device 72 is generally wider than the width of the second sleeve fastening device 74 such that the sleeve 10 can fit around and accommodate varying sizes of the fluid container 90.

As show in FIG. 1-4, each first handle fastening device 76 is positioned on the first surface 52 of the ribbon 50 adjacent to the top end of the ribbon 50. Each of the second handle fastening devices 78 are positioned on the first surface 12 of the piece of material 5 adjacent to the bottom edge 28 of the piece of material 5. Each of the second handle fastening devices 78 are positioned below one of the first handle fastening devices 76 such that when each ribbon 50 is folded over, the first handle fastening device 76 of the ribbon 50 can fasten to the second handle fastening device 78 of the piece of material 5 to form a handle 80 with a space 85 between the handle 80 and the first surface 12 of the piece of material 5, as shown in FIGS. 3 and 4.

As shown in FIG. 4, the piece of material 5 forms a sleeve 10 with handles 80 that is positioned around the fluid container 90 and allows a baby to hold onto the fluid container 90, such as a baby bottle, which allows the baby to independently consume the contents of the fluid container 90 without the assistance of a caregiver. The sleeve 10 is formed by wrapping the piece of material 5 around the fluid container 90 wherein the first surface 12 of the piece of material 5 faces away from the fluid container 90 and the second surface 14 of the piece of material 5 faces towards and in contact with the outer surface of the fluid container 90. The first sleeve fastening device 72 is fastened to the second sleeve fastening device 74 to secure the sleeve 10 onto the fluid container 90. To form the handles 80, each of the baby's hands are placed onto the first surface 12 of the piece of material 5 between one of the first handle fastening devices 76 and the corresponding second handle fastening devices 78. Then each of the ribbons 50 are folded over the baby's hand and the first handle fastening device 76 is fastened to the corresponding second handle fastening device 78. The baby's hands will be positioned within the space 85 between the handle 80 and the first surface 12 of the piece of material 5. Alternatively, the baby's hands can be positioned within the space 85 after the ribbons 50 are folded over and the first handle fastening device 76 is fastened to the corresponding second handle fastening device 78.

Although the present invention has been described with reference to specific embodiments, this description is not meant to be construed in a limiting sense. Various modifications of the disclosed embodiments, as well as alternative embodiments of the invention will become apparent to persons skilled in the art upon the reference to the above-description of the invention. It is, therefore, contemplated that the appended claims will cover such modifications that fall within the scope of the invention.

I claim:

1. A rectangular piece of flexible material that can form a sleeve for use by an infant or child for holding a fluid container comprising:
a first surface of said piece of material configured to face away from a container when the sleeve is positioned on a container;
a second surface of said piece of material configured to face toward and contact the container when the sleeve is positioned on the container;
a first side end, a second side end, a top edge, and a bottom edge of said piece of material;
a ribbon of flexible material extending from the top edge of said piece of material;
a first fastening device and second fastening device;
wherein a first element of the first fastening device is positioned adjacent the first side end of the piece of material and a second element of the first fastening device is positioned on the second side end of the piece of material wherein said material can be folded allowing the first element of the first fastening device to fasten to the second element of the first fastening device forming the sleeve; and
wherein a first element of the second fastening device is positioned adjacent the top end of the ribbon and a second element of the second fastening device is positioned adjacent the bottom edge of the piece of material wherein said ribbon can be folded over allowing the first element of the second fastening device to fasten to the second element of the second fastening device to form a handle with a space between said handle and said first surface of said piece of material.

2. The rectangular piece of flexible material that can form a sleeve for use by an infant or child for holding a fluid container of claim 1 wherein the first element of the first fastening device is positioned on the first surface of the piece of material and the second element of the first fastening device is positioned on the second surface of the piece of material such that the first side end of the piece of material attaches to the second side end of the piece of material in an overlapping fashion when the sleeve is positioned on the container.

3. The rectangular piece of flexible material that can form a sleeve for use by an infant or child for holding a fluid container of claim 1 wherein the first element of the second fastening device is positioned on a first surface of the ribbon coplanar with the first surface of the piece of material and the second element of the second fastening device is positioned on the first surface of the piece of material such that the first element of the second fastening device is capable of fastening to the second element of the second fastening device when the sleeve is positioned on the container.

4. The rectangular piece of flexible material that can form a sleeve for use by an infant or child for holding a fluid container of claim 2 wherein the first element of the second fastening device is positioned on a first surface of the ribbon coplanar with the first surface of the piece of material and the second element of the second fastening device is positioned on the first surface of the piece of material such that the first element of the second fastening device is capable of fastening to the second element of the second fastening device when the sleeve is positioned on the container.

5. The rectangular piece of flexible material that can form a sleeve for use by an infant or child for holding a fluid container of claim 1 wherein the first and second fastening devices are hook and loop fasteners.

6. The rectangular piece of flexible material that can form a sleeve for use by an infant or child for holding a fluid container of claim 1 wherein the first and second fastening devices are snaps.

7. The rectangular piece of flexible material that can form a sleeve for use by an infant or child for holding a fluid container of claim 4 wherein the first and second fastening devices are hook and loop fasteners.

8. The rectangular piece of flexible material that can form a sleeve for use by an infant or child for holding a fluid container of claim 4 wherein the first and second fastening devices are snaps.

9. A rectangular piece of flexible material that can form a sleeve for use by an infant or child for holding a fluid container comprising:
a first surface of said piece of material configured to face away from a container when the sleeve is positioned on the container;
a second surface of said piece of material configured to face toward and contact the container when the sleeve is positioned on the container;
a first side end, a second side end, a top edge, and a bottom edge of said piece of material;
a first ribbon of flexible material and second ribbon of flexible material wherein each ribbon extends from the top edge of said piece of material;
a first fastening device, second fastening device, and third fastening device;
wherein a first element of the first fastening device is positioned adjacent the first side end of the piece of material and a second element of the first fastening device is positioned on the second side end of the piece of material wherein said material can be folded allowing the first element of the first fastening device to fasten to the second element of the first fastening device forming the sleeve;
wherein a first element of the second fastening device is positioned adjacent the top end of the ribbon and a second element of the second fastening device is positioned adjacent the bottom edge of the piece of material wherein said ribbon can be folded over allowing the first element of the second fastening device to fasten to the second element of the second fastening device to form a first handle with a space between said first handle and said first surface of said piece of material; and
wherein a first element of the third fastening device is positioned adjacent the top end of the ribbon and a second element of the third fastening device is positioned adjacent the bottom edge of the piece of material wherein said ribbon can be folded over allowing the first element of the third fastening device to fasten to the second element of the third fastening device to form a second handle with a space between said second handle and said first surface of said piece of material.

10. The rectangular piece of flexible material that can form a sleeve for use by an infant or child for holding a fluid container of claim 9 wherein the first element of the first fastening device is positioned on the first surface of the piece of material and the second element of the first fastening device is positioned on the second surface of the piece of material such that the first side end of the piece of material attaches to the second side end of the piece of material in an overlapping fashion when the sleeve is positioned on the container.

11. The rectangular piece of flexible material that can form a sleeve for use by an infant or child for holding a fluid container of claim 9 wherein:
the first element of the second fastening device is positioned on a first surface of the first ribbon coplanar with the first surface of the piece of material and the second element of the second fastening device is positioned on the first surface of the piece of material such that the first element of the second fastening device is capable of fastening to the second element of the second fastening device when the sleeve is positioned on the container; and
wherein the first element of the third fastening device is positioned on a first surface of the second ribbon coplanar with the first surface of the piece of material and the second element of the third fastening device is positioned on the first surface of the piece of material such that the first element of the third fastening device is capable of fastening to the second element of the third fastening device when the sleeve is positioned on the container.

12. The rectangular piece of flexible material that can form a sleeve for use by an infant or child for holding a fluid container of claim 10 wherein:
the first element of the second fastening device is positioned on a first surface of the first ribbon coplanar with the first surface of the piece of material and the second element of the second fastening device is positioned on the first surface of the piece of material such that the first element of the second fastening device is capable of fastening to the second element of the second fastening device when the sleeve is positioned on the container; and
wherein the first element of the third fastening device is positioned on a first surface of the second ribbon coplanar with the first surface of the piece of material and the second element of the third fastening device is positioned on the first surface of the piece of material such that the first element of the third fastening device is capable of fastening to the second element of the third fastening device when the sleeve is positioned on the container.

13. The rectangular piece of flexible material that can form a sleeve for use by an infant or child for holding a fluid container of claim 9 wherein the first, second, and third fastening devices are hook and loop fasteners.

14. The rectangular piece of flexible material that can form a sleeve for use by an infant or child for holding a fluid container of claim 9 wherein the first, second, and third fastening devices are snaps.

15. The rectangular piece of flexible material that can form a sleeve for use by an infant or child for holding a fluid container of claim 12 wherein the first, second, and third fastening devices are hook and loop fasteners.

16. The rectangular piece of flexible material that can form a sleeve for use by an infant or child for holding a fluid container of claim 12 wherein the first, second, and third fastening devices are snaps.

17. A sleeve for use by an infant or child for holding a fluid container comprising:
a first surface of said sleeve wherein said first surface is configured to face away from a container when the sleeve is positioned on the container;
a second surface of said sleeve wherein said second surface is configured to face toward and contact the container when the sleeve is positioned on the container;
a top edge and a bottom edge of said sleeve; and
a first ribbon of flexible material and second ribbon of flexible material wherein one end of each ribbon extends from the top edge of the sleeve and the other end of each ribbon connects to the sleeve adjacent to the bottom edge such that each ribbon forms a handle with a space between said handles and said sleeve.

18. The sleeve for use by an infant or child for holding a fluid container of claim 17 wherein the first and second ribbons connect to the sleeve with a hook and loop fastener.

19. The sleeve for use by an infant or child for holding a fluid container of claim 17 wherein the first and second ribbons connect to the sleeve with snaps.
